(19) United States
(12) Patent Application Publication
(10) Pub. No.: US 2020/0387846 A1
(43) Pub. Date: Dec. 10, 2020

(54) SYSTEMS, METHODS, AND STORAGE MEDIA FOR DETERMINING THE IMPACT OF FAILURES OF INFORMATION SYSTEMS WITHIN AN ARCHITECTURE OF INFORMATION SYSTEMS

(71) Applicant: RiskLens, Inc., Spokane, WA (US)

(72) Inventors: Jack Allen Jones, Bloomington, IN (US); Justin Theriot, Mandeville, LA (US)

(21) Appl. No.: 16/435,603

(22) Filed: Jun. 10, 2019

(51) Int. Cl. G06Q 10/06; G06F 11/07; G06F 17/16; G06F 11/30; G06F 11/34

(52) U.S. Cl. CPC G06Q 10/06375; G06F 11/0709; G06F 11/079; G06F 11/3428; G06F 11/3048; G06F 11/3006; G06F 17/16

(57) ABSTRACT

Systems, methods, and storage media for determining the impact of failures of information systems within an architecture of information systems are disclosed. Exemplary implementations may: determine a base set of nodes; assign dependency values between pairs of the nodes in the base set; determine an intermediate set of nodes representing information systems in the architecture; assign dependency values between pairs of the nodes in the intermediate set and the nodes in the base set; monitor operating conditions of the information systems; assign an operating condition value to each node base on the operating conditions; and determine an operational status of at least one of the information systems based on operating condition values of nodes corresponding to other information systems and corresponding dependency values. The architecture can accomplish a mission and the a best case outcome of the mission and a worst case outcome of the mission can be determined.

### FIELD OF THE DISCLOSURE

The present disclosure relates to systems, methods, and storage media for determining the impact of failures of information systems within an architecture of information systems.

### BACKGROUND

Computers have become ubiquitous to the extent that virtually every business process is controlled by a computer or other information system. Business processes, manufacturing processes, services, and the like are all controlled by computers. As various processes and the like are interconnected, complex architectures of information systems have become commonplace. Many of these architectures are responsible for the control of complex functions, referred to as “missions” herein. For example, air traffic control is a mission that is based on an architecture that can include radar equipment, runway lights, weather instruments, navigational aids, and other information systems that are interconnected and dependent on one another. Evaluating the risk associated with failure of the various components of the architecture has become complex and, in some cases, virtually impossible.

The information security profession (and the broader enterprise risk management discipline to some degree) often does not clearly and consistently differentiate between “risk assessment” and “risk analysis”. There is a difference, however, which is important to understand. Risk assessments tend to encompass a broader context that includes processes and technologies that identify, evaluate, and report on risk-related concerns. Risk analysis, also referred to as “risk determination” herein, relates the evaluation component of the broader risk assessment process, which determines the significance of the identified risk concerns.

Virtually all risk assessment processes and tools attempt to risk-rate their findings in some fashion. Historically, these ratings are set using qualitative/ordinal scales and practitioner estimates (e.g., “this issue is high risk” or “this is a 4 on a scale of 1-to-5”) without undergoing any meaningful analysis. This methodology does not account for the interdependence of various information systems on an overall mission and does not provide for a likelihood of success of the mission of failure of the mission.

### SUMMARY

The disclosure herein relates to more effective risk analyses of interdependent architectures of information systems. One aspect of the present disclosure relates to a system configured for determining the impact of failures of information systems within an architecture of information systems. The system may include one or more hardware processors configured by machine-readable instructions. The processor(s) may be configured to determine a base set of nodes. Each node may represent an information system in the architecture. The processor(s) may be configured to assign dependency values between pairs of the nodes in the base set. The dependency values may represent a level of dependency between the pairs of the nodes. The processor(s) may be configured to determine an intermediate set of nodes representing information systems in the architecture. The information systems represented by the intermediate set of nodes may be distinct from the information systems represented by the base set of nodes. The processor(s) may be configured to assign dependency values between pairs of the nodes in the intermediate set and the nodes in the base set. The dependency values may represent a level of dependency between the pairs of the nodes. The processor(s) may be configured to monitor operating conditions of the information systems. The processor(s) may be configured to assign an operating condition value to each node base on the operating conditions. The operate condition values represent the operating condition of the corresponding information system. The processor(s) may be configured to determine an operational status of at least one of the information systems based on operating condition values of nodes corresponding to other information systems and corresponding dependency values.

Another aspect of the present disclosure relates to a method for determining the impact of failures of information systems within an architecture of information systems. The method may include determining a base set of nodes. Each node may represent an information system in the architecture. The method may include assigning dependency values between pairs of the nodes in the base set. The dependency values may represent a level of dependency between the pairs of the nodes. The method may include determining an intermediate set of nodes representing information systems in the architecture. The information systems represented by the intermediate set of nodes may be distinct from the information systems represented by the base set of nodes. The method may include assigning dependency values between pairs of the nodes in the intermediate set and the nodes in the base set. The dependency values may represent a level of dependency between the pairs of the nodes. The method may include monitoring operating conditions of the information systems. The method may include assigning an operating condition value to each node base on the operating conditions. The operating condition values represent the operating condition of the corresponding information system. The method may include determining an operational status of at least one of the information systems based on operating condition values of nodes corresponding to other information systems and corresponding dependency values.

Yet another aspect of the present disclosure relates to a non-transient computer-readable storage medium having instructions embodied thereon, the instructions being executable by one or more processors to perform a method for determining the impact of failures of information systems within an architecture of information systems. The method may include determining a base set of nodes. Each node may represent an information system in the architecture. The method may include assigning dependency values between pairs of the nodes in the base set. The dependency values may represent a level of dependency between the pairs of the nodes. The method may include determining an intermediate set of nodes representing information systems in the architecture. The information systems represented by the intermediate set of nodes may be distinct from the information systems represented by the base set of nodes. The method may include assigning dependency values between pairs of the nodes in the intermediate set and the nodes in the base set. The dependency values may represent a level of dependency between the pairs of the nodes. The method may include monitoring operating conditions of the information systems. The method may include assigning an operating condition value to each node base on the operating conditions. The operating condition values represent the operating condition of the corresponding information system. The method may include determining an operational status of at least one of the information systems based on operating condition values of nodes corresponding to other information systems and corresponding dependency values.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a schematic diagram illustrating an example of a stack of layers representing a mission.

FIG. 2a illustrates a single node and nomenclature used in accordance with one or more implementations.

FIG. 2b Illustrates a pair of nodes and a dependency therebetween.

FIG. 2c illustrates multiple levels of nodes and dependencies therebetween.

FIG. 2d illustrates nodes and dependencies between nodes to illustrate a conditional value.

FIG. 2e illustrates nodes and dependencies between nodes in more complex architecture model.

FIG. 3 illustrates an example of nodes in a single level and the corresponding dependencies.

FIG. 4 illustrates a model in accordance with a simple example in accordance with one or more implementations.

FIG. 5 illustrates a system configured for determining the impact of failures of information systems within an architecture of information systems, in accordance with one or more implementations.

FIG. 6 illustrates a method for determining the impact of failures of information systems within an architecture of information systems, in accordance with one or more implementations.

### DETAILED DESCRIPTION

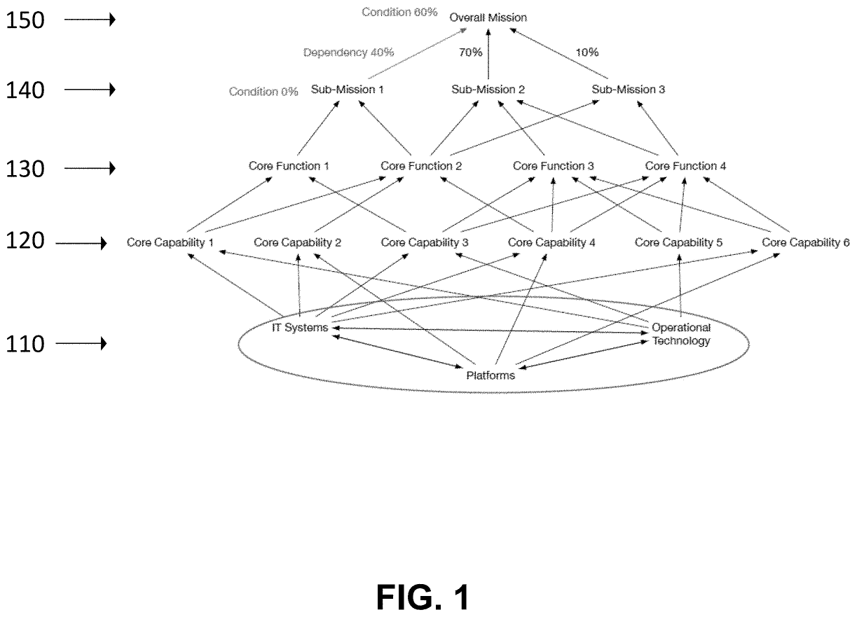

An architecture, including multiple information systems, that accomplishes a mission (e.g. air traffic control, a military exercise, complex financial transactions . . . ) can be modeled as stack 100 of elements or “nodes.” As shown in FIG. 1, nodes at the first (bottom) layer 110 of the stack can be nodes representing tangible assets, such as IT systems, platforms and operational technology (e.g. a radar device, a weather station, a machine tool . . . ), which may have interdependencies with each other and nodes at other levels of the stack. First layer 110 is where adverse events often first occur, and the effects of those events first materialize. Due to the dependencies from layer to layer (and interdependencies at this lower layer) in the stack, the impact of adverse events in first layer 110 flows laterally within this layer and vertically through the other layers of the stack.

Second layer 120 can include nodes representing capabilities, such as the capability of locating the position of an aircraft. Third layer 130 can include functions of the architecture, such as a control tower function in the case of an air traffic control mission. Fourth layer 140 can include nodes representing sub-missions, i.e. missions that are a subpart of the overall mission of the node of fifth layer 150. Fourth layer 140 will not be necessary in many implementations but is illustrated to show that there can be one or more layers of missions (sub-missions) that are components of a single overall mission.

Elements at each layer of the stack can be dependent, to some degree, on the operation of one or more of the elements in the adjacent layers. The level of dependence can be reflected as a percentage—e.g., if the overall mission is 40% dependent on Sub-Mission 1, then if Sub-Mission-1 becomes completely inoperable (a condition of 0%), then the Overall Mission condition is degraded by 40%. Note that there is no requirement for the dependencies from layer-to-layer to equal 100%. Nomenclature used to name the layers and elements within the hierarchy should reflect the nature/needs of the organization it reflects. For example, military organizations would likely use terminology that reflects their structure/purpose (e.g., a Core Function of Air Refueling, e.g. “Refueling Squadron”), while commercial or other industries might use business-related terminologies (e.g., a Core Function of Retail Banking).

The condition of each element in the stack can be represented using a linear scale, with 0% (inoperable) at the low end, and 100% (fully operational) at the high end. This can be expressed as a number between 0 and 1. As an example, a 40% dependency can be expressed as 0.4. This structure allows a system of m dependencies to model the effectiveness of the current state of each element, in which each node represents a system, function, or mission and a corresponding conditional state, e.g., running at 100% or lower. Edges between nodes indicate dependencies that affect the conditional state. The model permits risk determination of the effectiveness of the systems regarding the mission.

The mission is modeled as a sequential dynamical system (SDS), which is a class of graph dynamical systems. Concepts of graph theory are used to define notation, vertices, and edge functions. Dependencies are defined by the user/organization through policies regarding the mission, i.e., the overall desired function of the architecture as a whole. When policy changes, the dependencies can be updated to allow the model to match the current policies. By organizing our system as an SDS, the system can be analyzed for changes over-time. Moreover, simulations can be used to find weak areas in the architecture, leading to changes in the policy, strengthening the architecture, and increasing the chances of mission success.

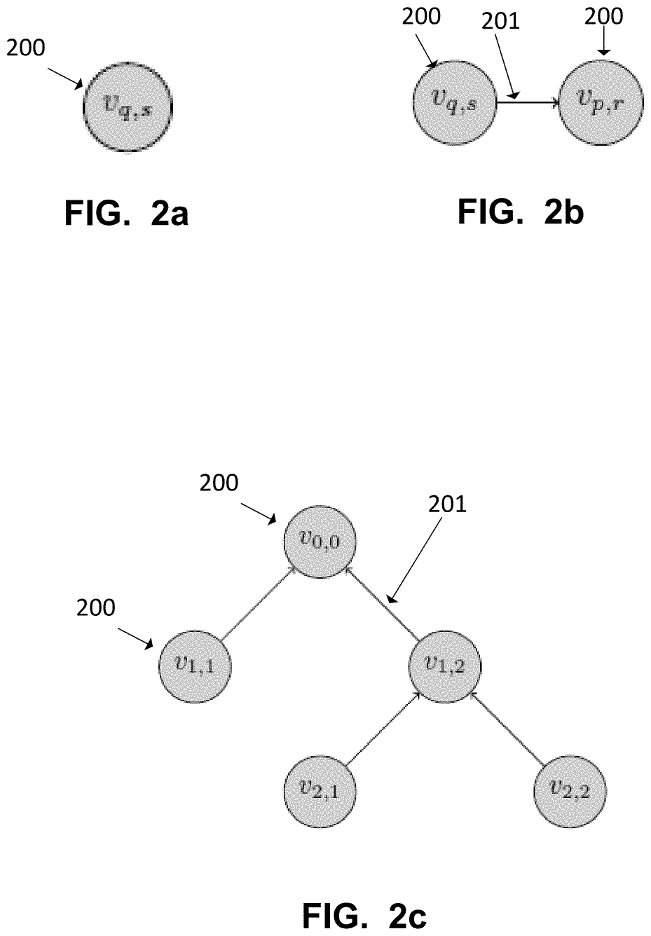

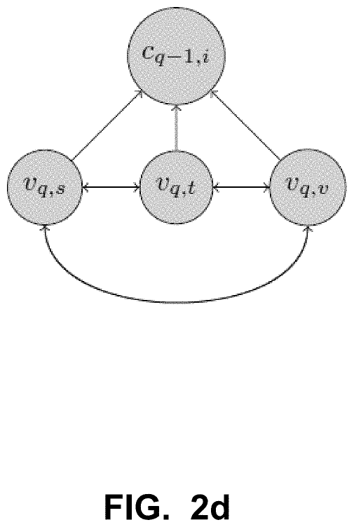

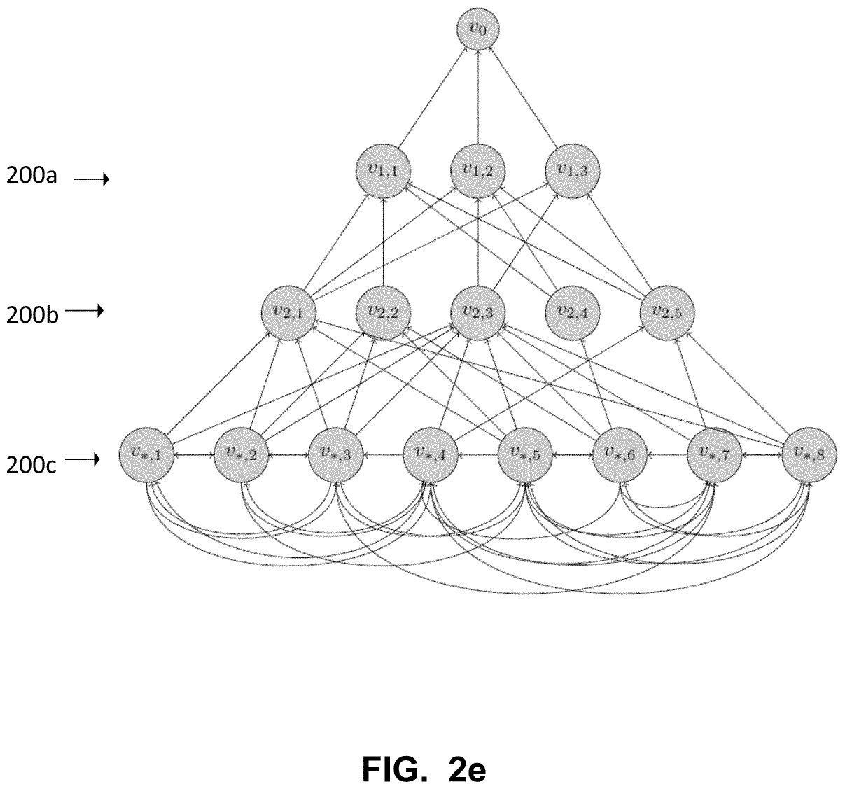

A disclosed implementation leverages the format disclosed in Thulasiraman, K. and Swamy, M. N. S. Graphs: Theory and Application, John Wiley & Sons, Canada, 1st Edition, 1992. by defining a graph G=(V, E) which consists of two sets, a finite set V of elements called vertices (or nodes), and a finite set E of elements called edges. The notation in disclosed implementations differs from the known notations by annotating a vertex (or node) as, ν_{q,s} on graph G. Where q is the hierarchy, and s is the index of the vertex in the hierarchy, with the vertex set annotated as V(G). An implementation uses s to annotate the index and in certain cases i and j will be used as is well-known notation in mathematics. The context where these are used are clear to one of skill in the art that they reference the index. FIG. 2a illustrates a graphical representation of a single node 200.

Each vertex node can represent an information system that is a part of the architecture. The phrase “information system” as used herein refers to any system of device in an architecture having a defined function that is used to achieve the mission. Information systems may be, in whole or in part, computers or computer systems. However, they may also be, in whole or in part, physical manipulation systems, such as a machine tool, radar apparatus, a vehicle, or the like. Various examples of information systems are disclosed in the implementations and specific examples provided below.

An edge is represented as a line segment between a pair of vertices. If the edges of a graph G are identified with an order paired of vertices, then G is considered a directed graph. The edge function between [symbol] and [symbol] as we define it is a dependency vector, e_{p,r}^{q,s}, for edges between the s-th vertex from level q and the r-th vertex from level p. If p=q then the vertices are on the same hierarchical level. The dependency vector can represent a weight. It is an n×1 vector on the vertex. The edge function is annotated as

e_{p,r}^{q,s}=(ν_{q,s},ν_{p,r}),e_{p,r}^{q,s}∈[0,1] (1)

As shown in FIG. 2b, the dependency between two vertices 200 can be expressed by arrow 201 pointing from the node having the dependency to the node on which it is dependent. Note that the values of the dependency vectors across a hierarchy do not necessarily have to sum to 1.

$$\begin{matrix}{\sum }_{s , r = 1}^{∞} {e}_{p , r}^{q , s} \neq 1 & ( 2 ) \\ {e}_{p , r}^{q , s} ∄ ( {υ}_{q , s} , {υ}_{p , r} ) = 0 & ( 3 )\end{matrix}$$

FIG. 2c illustrates and example of a portion of a graph showing how the novel notation works. Nodes 200 (only some of which are labeled) are assembled in a hierarchy with dependencies shown by lines 201 (only some of which are labeled). The bottom nodes [symbol] and [symbol] indicate that these nodes of the graph are on the second level of the graph (below the top node) and that there are at least two nodes at that level.

Conditional values, c_{q,s} can be introduced to define the relative status of each node. Unless the conditional value of a connected node in a lower level changes, the conditional value of a node will be set to 1 in this implementation. When a conditional value changes, the conditional values are derived through the following equations.

$$\begin{matrix} {c}_{q , 1} = f ( {c}_{q + 1 , s} , {e}_{p + 1 , r}^{q + 1 , s} ) & & ( 4 ) \\ f ( {c}_{q + 1 , s} , {e}_{p + 1 , r}^{q + 1 , s} ) = \{ \begin{matrix}1 & \frac{1}{n} {\sum }_{s = 1}^{n} {c}_{q , s} = 1 \\ 1 - max \{ {e}_{p + 1 , r}^{q + 1 , s} - ( {c}_{q + 1 , s} * {e}_{p + 1 , r}^{q + 1 , s} ) \} & 0 < \frac{1}{n} {\sum }_{s = 1}^{n} {c}_{q , s} < 1 \\ 0 & \frac{1}{n} {\sum }_{s = 1}^{n} {c}_{q , s} = 0\end{matrix} & & ( 5 )\end{matrix}$$

Note that, at the system interdependency level, the conditional values are updated based on the status of the system, no manual calculation is required. Since c_{q,s} is the conditional value, the status, and e_{p,r}^{q,s} is the dependency, i.e. the weight. Thus, we are looking at nodes, dependencies and the conditional values to calculate the vertex's own conditional value. The conditional value can be illustrated as in the example of FIG. 2d. Note that the conditional value of a particular node is dependent on nodes in the next level (below) the particular node. A conditional vector shown is matrix form below.

$$C = [ \begin{matrix}{c}_{q , s} \\ {c}_{q , r} \\ ⋮ \\ {c}_{q , i} \\ {c}_{q , j}\end{matrix} ]$$

A vertex ν_{q,r} in a directed graph G is a root of G if there are directed paths from ν_{q,r} to all the remaining vertices of G with the root vertex annotated as ν⁰. The root function s different and is discussed below. The bottom hierarchy of a graph G can be referred to as the “system inter-dependency level”, with the hierarchy annotated by an *, ν*,ᵣ, for example. The bottom hierarchy matrix in this implementation is square, as the dependencies are interdependent, with dependencies for each node against every other node. As one moves up the hierarchy, the dependency matrices do not have to be squared, as they are reliant on the systems or organizations below them.

To apply the model described above to a mission, the conditional value of the root vertex can be defined as the mission impact. An equation with a similar structure but different interpretation is introduced.

η_{q,s}=e_{p,r}^{q,s}−(c_{q,s}*e_{p,r}^{q,s}) (6)

Where, η_{q,s} represents the “negative effect”, i.e., the conditional value taken with the weight, which can be thought as the impact a specific node has on the overall mission success. The negative effect is defined by the conditional value which is calculated from the bottom up, and only one weight value.

The root vertex on graph G, [symbol] provides the mission impact values, S⁺; S⁻.

$$\begin{matrix}{S}^{+} = 1 - max \{ {η}_{q , s} \} & ( 7 ) \\ {S}^{-} = 1 - {\sum }_{s = 1}^{n} {η}_{q , s} & ( 8 )\end{matrix}$$

These values are interpreted as a probability interval of the best case, S⁺, and the worst case, S⁻ of the mission succeeding. Thus, the entire graph can be analyzed on how specific vertices impact the overall mission. Note that conditional values at the system inter-dependency level are determined by the relative strength of each item in the system, since it is dependent only upon itself. Moreover, as the vertex always depends on itself.

e_{p,r}^{q,s}=(ν_{q,s},ν_{q,s})=1, (9)

This is not depicted graphically herein to reduce the complexity.

A subgraph can be constructed within G, to have a root vertex, thus enabling the graph to be broken down or added to with ease. G′0=(V′,E′) is a subgraph of G if V′ and E′ are, respectively, subsets of V and E such that an edge ( [symbol] ) is an E′ only if [symbol] and [symbol] are in V′.

A mission impact metric can be thought of as probability measure. Using the three axioms as defined by Barakov's Probability Theory (Borovkov, Alexandr A. Probability Theory, Springer-Verlag, London, 4th Edition, 2013.)
1. P(A)≥0
2. P(Ω)=1
3. For disjoint events A₁, A₂, . . . , →P(∪Aⱼ)=ΣP(Aⱼ)

Barakov noted that a problem in which the set of all outcomes are uncountable is possible. For this a special class of subsets is selected which will be treated as events. Let the space of elementary events be an arbitrary set, and A be a system of subset of. Using Barakov's definition for sigma-algebra where a class of sets [symbol] has the following properties for any sequence of sets.

$${{⋃}^{∞}}_{n = 1} {A}_{n} ∈ ℱ , {{⋂}^{∞}}_{n = 1} {A}_{n} ∈ ℱ$$

An algebra is a class of set which is closed under a finite number of operations of taking complements, unions, and intersections. Given a set of Ω and a sigma algebra of [symbol] of its subsets; we are given a measurable space (Ω, [symbol] ). These concepts play an important role in building out an SDS diagram. Note that Sigma-algebra extends the finite operator to a countable set. Within a Barakov Probability the sets are uncountable, by introducing sigma-algebra Barakov's notion is extended to the countable.

Below, an example model is described. As shown in FIG. 2e, the top node shows the overall mission impact, providing the best case (S⁺) and worst case (S⁻) probabilities in successfully completing the mission. First tier nodes 200a ( [symbol] ) are added. The graph can be completely built out with second tier nodes 200b and third tier nodes 200c. The model can be represented as matrices for each level of the diagram.

$${C}^{*} = [ \begin{matrix}1 \\ 1 \\ 1 \\ 1 \\ 1 \\ 1 \\ 1 \\ 1\end{matrix} ] {D}^{*} = [ \begin{matrix}1.0 & 0.4 & 0.1 & 0.2 & 0.0 & 0.0 & 0.0 & 0.0 \\ 0.2 & 1.0 & 0.2 & 0.1 & 0.0 & 0.0 & 0.0 & 0.0 \\ 0.3 & 0.6 & 1.0 & 0.4 & 0.1 & 0.0 & 0.0 & 0.0 \\ 0.0 & 0.7 & 0.0 & 1.0 & 0.1 & 0.3 & 0.4 & 0.0 \\ 0.0 & 0.1 & 0.4 & 0.0 & 1.0 & 0.4 & 0.5 & 0.5 \\ 0.0 & 0.0 & 0.0 & 0.0 & 0.6 & 1.0 & 0.7 & 0.2 \\ 0.0 & 0.0 & 0.5 & 0.3 & 0.1 & 0.2 & 1.0 & 0.3 \\ 0.0 & 0.0 & 0.0 & 0.2 & 0.3 & 0.1 & 0.9 & 1.0\end{matrix} ]$$

$${C}^{2} = [ \begin{matrix}1 \\ 1 \\ 1 \\ 1 \\ 1 \\ 1 \\ 1 \\ 1\end{matrix} ] {D}^{2} = [ \begin{matrix}0.2 & 0.0 & 0.3 & 0.0 & 0.0 \\ 0.3 & 0.3 & 0.2 & 0.0 & 0.0 \\ 0.1 & 0.4 & 0.6 & 0.0 & 0.0 \\ 0.0 & 0.0 & 0.0 & 0.1 & 0.0 \\ 0.2 & 0.5 & 0.0 & 0.4 & 0.0 \\ 0.0 & 0.6 & 0.0 & 0.5 & 0.1 \\ 0.0 & 0.0 & 0.1 & 0.0 & 0.7 \\ 0.1 & 0.0 & 0.0 & 0.3 & 0.8\end{matrix} ]$$

$${C}^{1} = [ \begin{matrix}1 \\ 1 \\ 1 \\ 1 \\ 1\end{matrix} ] {D}^{1} = [ \begin{matrix}0.5 & 0.1 & 0.2 \\ 0.5 & 0.0 & 0.0 \\ 0.0 & 0.3 & 0.3 \\ 0.2 & 0.7 & 0.0 \\ 0.4 & 0.2 & 0.8\end{matrix} ]$$

$${C}^{0} = [ \begin{matrix}1 \\ 1 \\ 1\end{matrix} ] {D}^{0} = [ \begin{matrix}0.4 \\ 0.5 \\ 0.1\end{matrix} ] {N}^{0} = [ \begin{matrix}0.0 \\ 0.0 \\ 0.0\end{matrix} ]$$

We now show how a change in a condition value C effects the mission impact. Keep in mind that the mission impact based in the current conditions and dependencies are, S⁺=1 and S⁻=1. If one conditional value were to change at the bottom hierarchy, the model shows the mission impact changes. Only the conditional values change, as the dependency vectors do not change unless policy within the organization changes. For example, when conditional value C_{*,4} changes to 0 we can see how the process works:

$${C}^{2} = [ \begin{matrix}1 - max \{ ( 1.0 - ( 1.0 * 1.0 ) ) , ( 0.2 - ( 1.0 * 0.2 ) ) , ( 0.3 - ( 1.0 * 0.3 ) ) , ( 0.0 - ( 1.0 * 0.0 ) ) , … , ( 0.0 - ( 1.0 * 0.0 ) ) \} \\ 1 - max \{ ( 0.4 - ( 1.0 * 0.4 ) ) , ( 1.0 - ( 1.0 * 1.0 ) ) , ( 0.6 - ( 1.0 * 0.6 ) ) , ( 0.7 - ( 0.0 * 0.7 ) ) , … , ( 0.0 - ( 1.0 * 0.0 ) ) \} \\ 1 - max \{ ( 0.1 - ( 1.0 * 0.1 ) ) , ( 0.2 - ( 1.0 * 0.2 ) ) , ( 1.0 - ( 1.0 * 1.0 ) ) , ( 0.0 - ( 0.0 * 0.0 ) ) , … , ( 0.0 - ( 1.0 * 0.0 ) ) \} \\ 1 - max \{ ( 0.2 - ( 1.0 * 0.2 ) ) , ( 0.1 - ( 1.0 * 0.1 ) ) , ( 0.4 - ( 1.0 * 0.4 ) ) , ( 0.0 - ( 1.0 * 0.0 ) ) , … , ( 0.2 - ( 1.0 * 0.2 ) ) \} \\ 1 - max \{ ( 0.0 - ( 1.0 * 0.0 ) ) , ( 0.0 - ( 1.0 * 0.0 ) ) , ( 0.1 - ( 1.0 * 0.1 ) ) , ( 1.0 - ( 1.0 * 1.0 ) ) , … , ( 0.3 - ( 1.0 * 0.3 ) ) \} \\ 1 - max \{ ( 0.0 - ( 1.0 * 0.0 ) ) , ( 0.0 - ( 1.0 * 0.0 ) ) , ( 0.0 - ( 1.0 * 0.0 ) ) , ( 0.3 - ( 0.0 * 0.3 ) ) , … , ( 0.1 - ( 1.0 * 0.1 ) ) \} \\ 1 - max \{ ( 0.0 - ( 1.0 * 0.0 ) ) , ( 0.0 - ( 1.0 * 0.0 ) ) , ( 0.0 - ( 1.0 * 0.0 ) ) , ( 0.4 - ( 1.0 * 0.4 ) ) , … , ( 0.9 - ( 1.0 * 0.9 ) ) \} \\ 1 - max \{ ( 0.0 - ( 1.0 * 0.0 ) ) , ( 0.0 - ( 1.0 * 0.0 ) ) , ( 0.0 - ( 1.0 * 0.0 ) ) , ( 0.0 - ( 1.0 * 0.0 ) ) , … , ( 1.0 - ( 1.0 * 1.0 ) ) \}\end{matrix} ]$$

$${C}^{2} = [ \begin{matrix}1 - max \{ 0.0 , 0.0 , 0.0 , 0.0 , … , 0.0 \} \\ 1 - max \{ 0.0 , 0.0 , 0.0 , 0.7 , … , 0.0 \} \\ 1 - max \{ 0.0 , 0.0 , 0.0 , 0.0 , … , 0.0 \} \\ 1 - max \{ 0.0 , 0.0 , 0.0 , 1.0 , … , 0.0 \} \\ 1 - max \{ 0.0 , 0.0 , 0.0 , 0.0 , … , 0.0 \} \\ 1 - max \{ 0.0 , 0.0 , 0.0 , 0.0 , … , 0.0 \} \\ 1 - max \{ 0.0 , 0.0 , 0.0 , 0.0 , … , 0.0 \} \\ 1 - max \{ 0.0 , 0.0 , 0.0 , 0.0 , … , 0.0 \}\end{matrix} ] = [ \begin{matrix}1 - 0.0 \\ 1 - 0.7 \\ 1 - 0.0 \\ 1 - 1.0 \\ 1 - 0.1 \\ 1 - 0.3 \\ 1 - 0.4 \\ 1 - 0.0\end{matrix} ] = [ \begin{matrix}1.0 \\ 0.3 \\ 1.0 \\ 0.0 \\ 0.9 \\ 0.7 \\ 0.6 \\ 1.0\end{matrix} ]$$

All conditional values moving up the graph are shown below. It can be seen that the mission impact based on the new adjusted conditional vectors are, S⁺=0:95 and S⁻=0:88

$${C}^{*} = [ \begin{matrix}1.0 \\ 1.0 \\ 1.0 \\ 0.0 \\ 1.0 \\ 1.0 \\ 1.0 \\ 1.0\end{matrix} ] {C}^{2} = [ \begin{matrix}1.0 \\ 0.3 \\ 1.0 \\ 0.0 \\ 0.9 \\ 0.7 \\ 0.6 \\ 1.0\end{matrix} ] {C}^{1} = [ \begin{matrix}0.79 \\ 0.79 \\ 0.86 \\ 0.85 \\ 0.72\end{matrix} ] {C}^{0} = [ \begin{matrix}0.89 \\ 0.90 \\ 0.78\end{matrix} ] {N}^{0} = [ \begin{matrix}0.04 \\ 0.05 \\ 0.02\end{matrix} ]$$

Below a multidimensional mission impact model is defined as an SDS. First, we show that a sequential dynamical system consists of four objects based on the notes of Padraic Bartlett (Bartlett, Padraic. Lecture 6: Sequential Dynamical Systems. Math 137B Notes, UCSB, 2014. The four objects are:
1. A base graph, which is a graph G on n vertices { [symbol] , . . . [symbol] }.
2. A collection of vertex states K where K is finite, with K= [symbol] p∈[0,1]. The compromised of the conditional value and the edge weights.
3. A collection of vertex functions, [symbol] that take in the state of the vertex and the states of the neighbors of that vertex and out a vertex state, we can think this as the conditional out-flow and the in-flow ow from a vertex. Formally, if [symbol] denotes the number of neighbors of ν, we think of these functions as map K^{n(ν)+1}→K, i.e., the local update rules.
4. An update order π=(ν_{π(1)}, . . . , ν_{π(n)}) that consists of some permutation of the vertices of [symbol] . Update orders start from the vertex, its neighbors then continue up hierarchy until reaching the root.

The graph is structured the same, continuing to use the notation for vertices, [symbol] A vertex, [symbol] has a conditional value which can now be defined as the vertex state. The dependency vector can be used to define the vertex functions. Continuing use of Padraic Bartlett's notes, and applying concepts from Barrettt, C. L., Mortveit, H. S., Reidys, C. M., Elements of a theory of simulation II: sequential dynamical systems, Applied Mathematics and Computation, 107: 121-136, 2000, any element \vec{x}∈Kⁿ a system state and associate it to the vertices of G by labeling vertex [symbol] with the state x_{q,r}. Given any vertex state x_{q,r} and any vertex ν_{q,r}, let \vec{x_{vq,r}} denote the array of \vec{x_{q,r}} coordinates that correspond to the vertex ν_{q,r} and its neighbors; referred to as the dependency vector herein.

The local function for each vertex ν and associated vertex function ƒ_{ν}, is defined by F_{ν}:Kⁿ→Kⁿ as the following map.

$$\begin{matrix}{proj}_{G} [ i ] = {ℱ}_{p}^{n} \to {ℱ}_{p}^{{δ}_{1} + 1} , ( {x}_{1} , … , {x}_{n} ) \to ( {x}_{j 1} , … , {x}_{i} , … , {x}_{j {δ}_{1}} ) & ( 10 ) \\ {ℱ}_{i , G} ( {( {x}_{j} )}_{j} ) = ( {x}_{1} , … , {x}_{i - 1} , {g}_{i} ( x ) , {x}_{i + 1} , … , {x}_{n} ) & ( 11 )\end{matrix}$$

In other words, the local function F_{ν} is simply the map that takes in any system state \vec{x} and updates the coordinate corresponding to ν with ƒ_{ν}(\vec{x_{ν}}) such that:

$${f}_{{v}_{q , r}} ( \vec{{x}_{{v}_{q , r}}} ) = {c}_{q , i} = 1 - max \{ {e}_{r , s}^{q - 1} - ( {c}_{q - 1 , j} * {e}_{r , s}^{q - 1} ) \} \qquad ( 12 )$$

Now that we have introduced the maps [symbol] _{i,G}, we can introduce SDS over a graph G in the form.

$$[ {ℱ}_{G} , π ] = {\prod }_{i = 1}^{n} {F}_{π ( i ) , G} \text{:} {ℱ}_{p}^{n} \to {ℱ}_{p}^{n}$$

As noted above, the measure space is being used here to define the infinite countable subsets. Conceptually, applying [F_{G},π] to a given initial state can be thought of as advancing the SDS forward in time by one step. Specifically, [F_{G},π] can be thought of as a system update map. Given any initial state \vec{x}, it tells us how \vec{x} changes after we run it through all of the local functions using the update order. Further, the SDS with system update map [F_{G},π], along with the initial state \vec{x}, for our system, can define the forward orbit, which can be thought of as a time series, under the map as the sequence,

$${O}^{+} ( \vec{x} ) = ( \vec{x} , [ {F}_{G} , π ] \vec{(} x ) , {[ {F}_{G} , π ]}^{2} \vec{(} x ) , {[ {F}_{G} , π ]}^{3} \vec{(} x ) , … ) \qquad ( 14 )$$

Since the SDS-map represents how the system changes over one time period, this sequence represents the system with initial state {right arrow over (()}x) over time.

Some examples, applying the graph described above to the requirements of sequential dynamical systems are described below. In a first example, the bottom vector and matrix, can be defined as:

$${C}^{*} = [ \begin{matrix}1 \\ 1 \\ 1 \\ 1 \\ 1 \\ 1 \\ 1 \\ 1\end{matrix} ] {x}^{*} = [ \begin{matrix}1.0 & 0.4 & 0.1 & 0.2 & 0.0 & 0.0 & 0.0 & 0.0 \\ 0.2 & 1.0 & 0.2 & 0.1 & 0.0 & 0.0 & 0.0 & 0.0 \\ 0.3 & 0.6 & 1.0 & 0.4 & 0.1 & 0.0 & 0.0 & 0.0 \\ 0.0 & 0.7 & 0.0 & 1.0 & 0.1 & 0.3 & 0.4 & 0.0 \\ 0.0 & 0.1 & 0.4 & 0.0 & 1.0 & 0.4 & 0.5 & 0.5 \\ 0.0 & 0.0 & 0.0 & 0.0 & 0.6 & 1.0 & 0.7 & 0.2 \\ 0.0 & 0.0 & 0.5 & 0.3 & 0.1 & 0.2 & 1.0 & 0.3 \\ 0.0 & 0.0 & 0.0 & 0.2 & 0.3 & 0.1 & 0.9 & 1.0\end{matrix} ]$$

Instead of stating the values have changed, we use the terms update, such that the entire graph, system updates.

$${C}^{*} [ \begin{matrix}1.0 \\ 1.0 \\ 1.0 \\ 0.0 \\ 1.0 \\ 1.0 \\ 1.0 \\ 1.0\end{matrix} ]$$

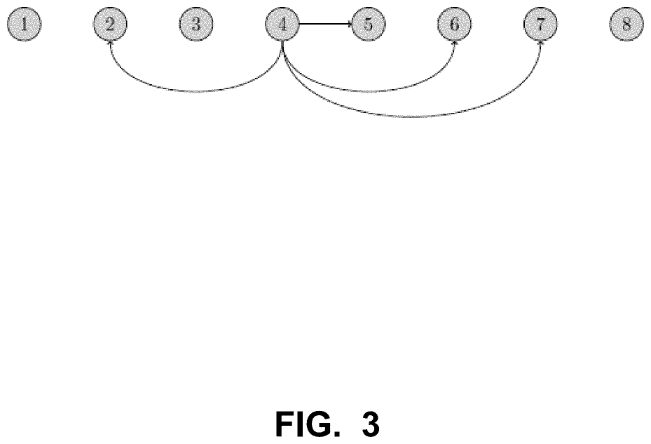

FIG. 3 illustrates this the update of a conditional value by illustrating a simple model of only two levels. Moving up the hierarchy to the nodes affected by the changes, the nodes can be updated until the root node is reached.

The update equation follows:

$$[ {F}_{G} , π ] = F \text{?} • F \text{?} F \text{?} • F \text{?} •…• F \text{?} • F \text{?} • F \text{?} . \\ \text{?} \text{indicates text missing or illegible when filed} \qquad ( 15 )$$

As updates continue, the forward orbit, O⁺(\vec{x}) begins to provide information on the behavior of the system being modeled.

Given the update we have the following:

$${O}^{+} ( \vec{x} ) = [ ( 1.0 , 1.0 ) , ( 0.95 , 0.88 ) ] \qquad ( 16 )$$

Note that the forward orbit contains the image of the entire system, not just the mission success rating as shown. Certain nodes will cause greater risk of mission success that can be determined through analysis of the SDS-Mapp. For example, when one node fails as it did in the above example, weak spots in the system, which can cause mission success collapse, become apparent. Through simulations a greater chance of mission success can be achieved through the analysis of the entire system and strengthening the weaker areas. The number of different SDS can be analyzed based on:

$${a}_{{( {f}_{k} )}_{k}} ( G ) \vert [ {ℱ}_{g} , π ] \vert π ∈ {𝒮}_{n} \vert \qquad ( 17 )$$

As shown in FIG. 3, nodes in a level can have dependencies on one another. However, this adds a level of complexity that obscures the description. Therefore, the example below does not include intra-level dependencies.

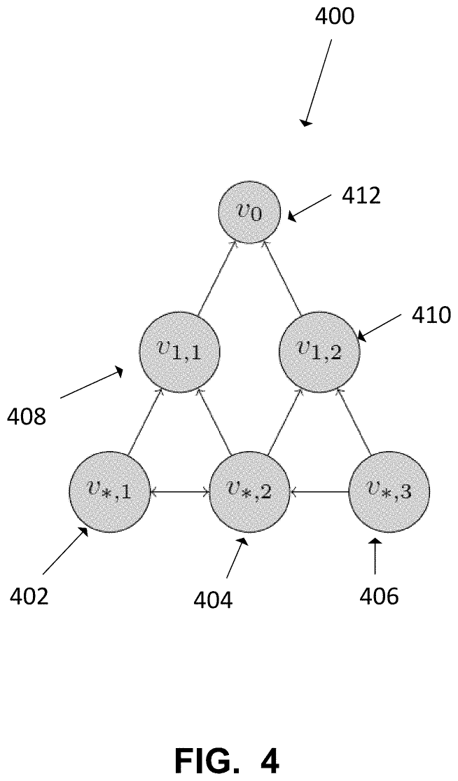

A very simple example applied to an air traffic control system will be described below with reference to system model 400 shown in FIG. 4. 400. In model 400, at the bottom level, node 402 represents radar equipment, node 404 represents radio equipment, and node 406 represents runway lights. The nodes have the following conditional values, using the notation described above.

$${C}^{*} = [ \begin{matrix}1 \\ 1 \\ 1\end{matrix} ]$$

Keep in mind that, once the model is established, these values can be updated based on a real time feed. As a result of such an update, the entire model will update from the bottom up. Dependencies are shown between nodes 402, 404, and 406 by arrows in the manner described above. A dependency matrix of this level is shown below.

$${D}^{*} = [ \begin{matrix}1.0 & 0.6 & 0.0 \\ 0.4 & 1.0 & 0.5 \\ 0.0 & 0.0 & 1.0\end{matrix} ]$$

This dependency matrix represents how, and to what extent, the equipment represented by the respective nodes depends on one another. This is important in providing the conditional values moving up the hierarchy of the model.

The conditional of ν_{*;1} moving up the hierarchy is based on the conditional value (the current working status of the equipment) and the dependency. Node 408 represents Radar Approach Control (RAPCON), military terminology for a system providing airspace control, similar to TRACON in the civilian sector. Node 410 represents a control tower and node 412 represents the mission of air traffic control. Of course, there are other elements that could be represented in the model, but which are omitted for simplicity and clarity.

Thus, the conditional value for the RAPCON (node 408) or tower (node 410) can be calculated with the following equation.

$$f ( {c}_{s , 1} , {e}_{s , 1} ) = {e}_{s , 1} - ( {c}_{s , 1} * {e}_{s , 1} ) \to 1 - ( 1 * 1 ) = 0$$

Expanding this Equation Yields:

$$f ( {c}_{q + 1 , s} , {e}_{p + 1 , r}^{q + 1 , s} ) = \{ \begin{matrix}1 & \frac{1}{n} {\sum }_{s = 1}^{n} {c}_{q , s} = 1 \\ 1 - max \{ {e}_{p - 1 , r}^{q - 1 , s} - ( {c}_{q - 1 , s} * {e}_{p - 1 , r}^{q - 1 , s} ) \} & 0 < \frac{1}{n} {\sum }_{s = 1}^{n} {c}_{q , s} < 1 \\ 0 & \frac{1}{n} {\sum }_{s = 1}^{n} {c}_{q , s} = 0 \end{matrix}$$

Note that RAPCON node 408 depends on radar node 402 and radio node 404 while tower node 410 depends on radio node 404 and runway lights 406. An example of the Dependency matrix for this the second level of the hierarchy of this model is below.

$${D}^{1} = [ \begin{matrix}0.7 & 0.0 \\ 0.8 & 0.8 \\ 0.0 & 0.4\end{matrix} ]$$

The first column of the dependency matrix corresponds to RAPCON node 408 and the second column corresponds to tower node 410. The rows correspond to nodes 401, 404, and 406 respectively. Based on policies articulated by the enterprise, it is determined that RAPCON is 70% dependent on radar, 80% dependent on radio, and 0% dependent on runway lights (recall that there is not arrow between RAPCON node 408 and runway lights node 406). Similarly, the tower is 0% dependent on radar, 80% dependent on radio, and 40% dependent on runway lights.

Node 412 is a root node for the mission that connects RAPCON node 408 and tower node 410. The mission is assigned a 70% dependency RAPCON and a 50% dependency on the tower. This can be express as the following dependency matrix for the root level.

$${D}^{0} = [ \begin{matrix}0.7 \\ 0.5\end{matrix} ]$$

Since all equipment starts in the fully operational state, equation 1 can be applied setting the conditional values to 100%, resulting in an indicated mission success rate of 100%. However, when a piece of equipment associated with a node changes its conditional value, i.e. its operational status, the system will update. For example if the radar associated with radar node 402 becomes non-operational, the bottom row conditional vector is updated as shown below.

$${C}^{*} = [ \begin{matrix}0 \\ 1 \\ 1\end{matrix} ]$$

As a result, the entire system is updated in the following manner. Since the radar node 402 is out the radar's conditional value is 0. Where this becomes interesting is in how this effects the RAPCON and Tower. The radio's conditional value drops to 40% via the following simplified equation.

c_{*,2}=1−max{(0.6−(0*0.0)),(1−(1*1)),(1−(0*1))}

c_{*,2}=1−max{0.6,0,0}=1−0.6=0.4

The vector matrix in this state is set forth below.

$${C}^{1} = [ \begin{matrix}0.0 \\ 0.4 \\ 1.0\end{matrix} ] {D}^{1} = [ \begin{matrix}0.7 & 0.0 \\ 0.8 & 0.8 \\ 0.0 & 0.4\end{matrix} ]$$

The matrix for the conditional values of the RAPCON, node 408, and the tower, node 410, is below.

$${C}^{0} = [ \begin{matrix}0.30 \\ 0.52\end{matrix} ]$$

The RAPCON conditional value can be calculated with the following equation using the vector C¹ and the matrix D¹.

c_{1,1}=1−max{(0.7−(0*0.7)),(0.8−(0.4*0.8)),(0−(1*0))}

c_{1,1}=1−max{0.7,0.48,0}=1−0.7=0.3

The tower, node 410, conditional value can be calculated in a similar manner except the second column of the matrix D¹ is used. As noted above, the values D⁰ for the RAPCON and tower are 0.7 and 0.5 respectively.

$${D}^{0} = [ \begin{matrix}0.7 \\ 0.5\end{matrix} ]$$

Thus, the negative values are calculated via the equations below.

$${η}_{q , s} = {e}_{p , r}^{q , s} - ( {c}_{q , s} * {e}_{p , r}^{q , s} )$$

$${N}^{0} = [ \begin{matrix}0.49 \\ 0.24\end{matrix} ]$$

$${N}_{1}^{0} = 0.7 - ( 0.3 * 0.7 ) = 0.49$$

$${N}_{2}^{0} = 0.5 - ( 0.50 * 0.5 ) = 0.24$$

A final set of equations can be used to calculate the the mission impact, S⁺ and S⁻. These values are applied as a probability interval of the best case, S⁺, and the worst case S⁻, of the mission succeeding.

$${S}^{+} = 1 - max \{ {η}_{q , s} \}$$

$${S}^{-} = 1 - {\sum }_{s = 1}^{n} {η}_{q , s}$$

$${S}^{+} = 1 - max \{ 0.49 , 0.24 \} = 1 - 0.49 = 0.51$$

$${S}^{-} = 1 - {\sum }_{s = 1}^{2} \{ 0.49 , 0.24 \} = 1 - 0.73 = 0.27$$

In the example, the best case outcome is 51% and the worst case outcome is 27%. When an equipment's condition is updated, the system will recalculate the mission values based on the steps disclosed above. Each time an update occurs, the update is timestamped to allow analysis of a sequential dynamical system.

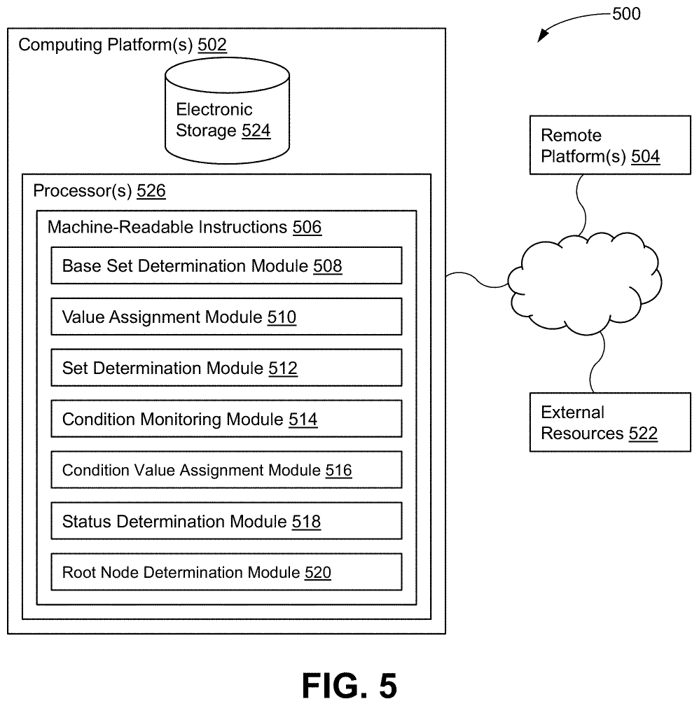

FIG. 5 illustrates a computer system 500 configured for determining the impact of failures of information systems within an architecture of information systems, in accordance with one or more implementations. System 500 stores and processes the matrices and other values noted above to create and/or analyze the mission impact model to thereby determine success or failure of the mission of a real world physical system, such as an air traffic control system. In some implementations, system 500 may include one or more servers 502. Server(s) 502 may be configured to communicate with one or more client computing platforms 104 according to a client/server architecture and/or other architectures. Client computing platform(s) 104 may be configured to communicate with other client computing platforms via server(s) 502 and/or according to a peer-to-peer architecture and/or other architectures. Users may access system 100 via client computing platform(s) 504.

Server(s) 502 may be configured by machine-readable instructions 506. Machine-readable instructions 506 may include one or more instruction modules. The instruction modules may include computer program modules. The instruction modules may include one or more of base set determination module 508, value assignment module 510, set determination module 512, condition monitoring module 514, condition value assignment module 516, status determination module 518, root node determination module 520, and/or other instruction modules.

Base set determination module 508 may be configured to determine a base set of nodes. Each node may represent an information system, such as radar equipment or runway lights, in the architecture. It can be seen that the phrase “information system” as used herein is broadly construed as any type of system that is used in the specified mission and from which a operating status can be ascertained. Value assignment module 510 may be configured to assign dependency values between pairs of the nodes in the base set. The dependency values may represent a level of dependency between the pairs of the nodes. Value assignment module 510 may also be configured to assign dependency values between pairs of the nodes in the intermediate set and the nodes in the base set. The dependency values may represent a level of dependency between the pairs of the nodes.

Value assignment module 510 may be configured to assign dependency values between nodes in the intermediate set and the root node. As noted above, the dependency values may be expressed as a number between 0 and 1 wherein 0 represents no dependency and wherein 1 represents a full dependency. Each node in each subset of nodes may have dependency values between pairs of the nodes therein and the adjacent subset of nodes. The dependency values may be stored as a series of matrices, such as the matrices disclosed above.

Set determination module 512 may be configured to determine an intermediate set of nodes representing information systems in the architecture. The intermediate set of nodes may include multiple subsets of nodes in a tree structure. The information systems represented by the intermediate set of nodes may be distinct from the information systems represented by the base set of nodes.

Condition monitoring module 514 may be configured to monitor operating conditions of the information systems. Condition value assignment module 516 may be configured to assign an operating condition value to each node base on the operating conditions. The operating condition values represent the operating condition of the corresponding information system.

Status determination module 518 may be configured to determine an operational status of at least one of the information systems based on operating condition values of nodes corresponding to other information systems and corresponding dependency values. The operating condition values may be binary with 1 representing full operation and 0 representing less than full operation.

Root node determination module 520 may be configured to determine a root node that represents the entirety of the architecture. The determining may include determining an operational status of the information system corresponding to the root node. The operational status of the root node may be the impact of the operating conditions on the function of the mission. In some implementations, the operational values may be stored as a set of matrices as set forth in the examples above.

In some implementations, server(s) 502, client computing platform(s) 104, and/or external resources 122 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 502, client computing platform(s) 104, and/or external resources 122 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 122, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 122 may include sources of information outside of system 100, external entities participating with system 100, and/or other resources. In some implementations, some or all of the functionality attributed herein to external resources 122 may be provided by resources included in system 100.

Server(s) 502 may include electronic storage 524, one or more processors 526, and/or other components. Server(s) 502 may include communication lines, or ports to enable the exchange of information with a network and/or other computing platforms. Illustration of server(s) 502 in FIG. 5 is not intended to be limiting. Server(s) 502 may include a plurality of hardware, software, and/or firmware components operating together to provide the functionality attributed herein to server(s) 502. For example, server(s) 502 may be implemented by a cloud of computing platforms operating together as server(s) 502.

Electronic storage 524 may comprise non-transitory storage media that electronically stores information. The electronic storage media of electronic storage 524 may include one or both of system storage that is provided integrally (i.e., substantially non-removable) with server(s) 502 and/or removable storage that is removably connectable to server(s) 502 via, for example, a port (e.g., a USB port, a firewire port, etc.) or a drive (e.g., a disk drive, etc.). Electronic storage 524 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 524 may include one or more virtual storage resources (e.g., cloud storage, a virtual private network, and/or other virtual storage resources). Electronic storage 524 may store software algorithms, information determined by processor(s) 526, information received from server(s) 502, information received from client computing platform(s) 104, and/or other information that enables server(s) 502 to function as described herein.

Processor(s) 526 may be configured to provide information processing capabilities in server(s) 502. As such, processor(s) 526 may include one or more of a digital processor, an analog processor, a digital circuit designed to process information, an analog circuit designed to process information, a state machine, and/or other mechanisms for electronically processing information. Although processor(s) 526 is shown in FIG. 5 as a single entity, this is for illustrative purposes only. In some implementations, processor(s) 526 may include a plurality of processing units. These processing units may be physically located within the same device, or processor(s) 526 may represent processing functionality of a plurality of devices operating in coordination. Processor(s) 526 may be configured to execute modules 508, 510, 512, 514, 516, 518, and/or 520, and/or other modules. Processor(s) 526 may be configured to execute modules 508, 510, 512, 514, 516, 518, and/or 520, and/or other modules by software; hardware; firmware; some combination of software, hardware, and/or firmware; and/or other mechanisms for configuring processing capabilities on processor(s) 526. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, 514, 516, 518, and/or 520 are illustrated in FIG. 5 as being implemented within a single processing unit, in implementations in which processor(s) 526 includes multiple processing units, one or more of modules 508, 510, 512, 514, 516, 518, and/or 520 may be implemented remotely from the other modules. The description of the functionality provided by the different modules 508, 510, 512, 514, 516, 518, and/or 520 described below is for illustrative purposes, and is not intended to be limiting, as any of modules 508, 510, 512, 514, 516, 518, and/or 520 may provide more or less functionality than is described. For example, one or more of modules 508, 510, 512, 514, 516, 518, and/or 520 may be eliminated, and some or all of its functionality may be provided by other ones of modules 508, 510, 512, 514, 516, 518, and/or 520. As another example, processor(s) 526 may be configured to execute one or more additional modules that may perform some or all of the functionality attributed below to one of modules 508, 510, 512, 514, 516, 518, and/or 520.

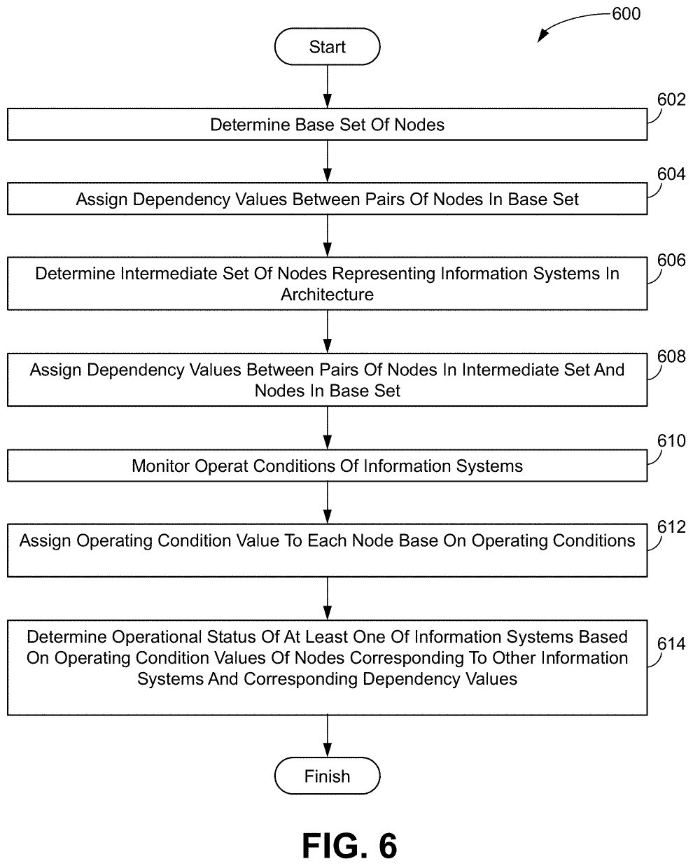

FIG. 6 illustrates a method 600 for determining the impact of failures of information systems within an architecture of information systems, in accordance with one or more implementations. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

An operation 602 may include determining a base set of nodes. Each node may represent an information system in the architecture. Operation 602 may be performed by one or more hardware processors configured by machine-readable instructions including a module that is the same as or similar to base set determination module 508, in accordance with one or more implementations.

An operation 604 may include assigning dependency values between pairs of the nodes in the base set. The dependency values may represent a level of dependency between the pairs of the nodes. Operation 604 may be performed by one or more hardware processors configured by machine-readable instructions including a module that is the same as or similar to value assignment module 510, in accordance with one or more implementations.

An operation 606 may include determining an intermediate set of nodes representing information systems in the architecture. The information systems represented by the intermediate set of nodes may be distinct from the information systems represented by the base set of nodes. Operation 606 may be performed by one or more hardware processors configured by machine-readable instructions including a module that is the same as or similar to set determination module 512, in accordance with one or more implementations.

An operation 608 may include assigning dependency values between pairs of the nodes in the intermediate set and the nodes in the base set. The dependency values may represent a level of dependency between the pairs of the nodes. Operation 208 may be performed by one or more hardware processors configured by machine-readable instructions including a module that is the same as or similar to value assignment module 510, in accordance with one or more implementations.

An operation 610 may include monitoring operating conditions of the information systems. Operation 610 may be performed by one or more hardware processors configured by machine-readable instructions including a module that is the same as or similar to condition monitoring module 514, in accordance with one or more implementations.

An operation 612 may include assigning an operating condition value to each node base on the operating conditions. The operating condition values represent the operating condition of the corresponding information system. Operation 612 may be performed by one or more hardware processors configured by machine-readable instructions including a module that is the same as or similar to condition value assignment module 516, in accordance with one or more implementations.

An operation 614 may include determining an operational status of at least one of the information systems based on operating condition values of nodes corresponding to other information systems and corresponding dependency values. Operation 614 may be performed by one or more hardware processors configured by machine-readable instructions including a module that is the same as or similar to status determination module 518, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for determining the impact of failures of information systems within an architecture of information systems, the system comprising:
one or more hardware processors configured by machine-readable instructions to:
determine a base set of nodes, each node representing an information system in the architecture;
assign dependency values between pairs of the nodes in the base set, the dependency values representing a level of dependency between the pairs of the nodes;
determine an intermediate set of nodes representing information systems in the architecture, the information systems represented by the intermediate set of nodes being distinct from the information systems represented by the base set of nodes;
assign dependency values between pairs of the nodes in the intermediate set and the nodes in the base set, the dependency values representing a level of dependency between the pairs of the nodes;
monitor operating conditions of the information systems;
assign an operating condition value to each node base on the operating conditions, whereby the operating condition values represent the operating condition of the corresponding information system; and
determine an operational status of at least one of the information systems based on operating condition values of nodes corresponding to other information systems and corresponding dependency values.

2. The system of claim 1, wherein the dependency values are expressed as a number between 0 and 1 wherein 0 represents no dependency and wherein 1 represents a full dependency.

3. The system of claim 2, wherein the operating condition values are binary with 1 representing full operation and 0 representing less than full operation.

4. The system of claim 3, wherein the one or more hardware processors are further configured by machine-readable instructions to:
determine a root node that represents the entirety of the architecture;
assign dependency values between nodes in the intermediate set and the root node.

5. The system of claim 4, wherein the intermediate set of nodes comprises multiple subsets of nodes in a tree structure, wherein each node in each subset of nodes has dependency values between pairs of the nodes therein and the adjacent subset of nodes.

6. The system of claim 4, wherein the dependency values are stored as a series of matrices.

7. The system of claim 4, wherein the operational values are stored as a set of matrices.

8. The system of claim 1, wherein the architecture accomplishes a mission and the one or more hardware processors are further configured by machine-readable instructions to determine a best case outcome of the mission and a worst case outcome of the mission.

9. A method for determining the impact of failures of information systems within an architecture of information systems, the method comprising:
determining a base set of nodes, each node representing an information system in the architecture;
assigning dependency values between pairs of the nodes in the base set, the dependency values representing a level of dependency between the pairs of the nodes;
determining an intermediate set of nodes representing information systems in the architecture, the information systems represented by the intermediate set of nodes being distinct from the information systems represented by the base set of nodes;
assigning dependency values between pairs of the nodes in the intermediate set and the nodes in the base set, the dependency values representing a level of dependency between the pairs of the nodes;
monitoring operating conditions of the information systems;
assigning an operating condition value to each node base on the operating conditions, whereby the operating condition values represent the operating condition of the corresponding information system; and
determining an operational status of at least one of the information systems based on operating condition values of nodes corresponding to other information systems and corresponding dependency values.

10. The method of claim 9, wherein the dependency values are expressed as a number between 0 and 1 wherein 0 represents no dependency and wherein 1 represents a full dependency.

11. The method of claim 10, wherein the operating condition values are binary with 1 representing full operation and 0 representing less than full operation.

12. The method of claim 11, further comprising:
determining a root node that represents the entirety of the architecture; and
assigning dependency values between nodes in the intermediate set and the root node.

13. The method of claim 12, wherein the intermediate set of nodes comprises multiple subsets of nodes in a tree structure, wherein each node in each subset of nodes has dependency values between pairs of the nodes therein and the adjacent subset of nodes.

14. The method of claim 13, wherein the dependency values are stored as a series of matrices.

15. The method of claim 14, wherein the operational values are stored as a set of matrices.

16. The method of claim 9, wherein the architecture accomplishes a mission and further comprising determining a best case outcome of the mission and a worst case outcome of the mission.

17. A non-transient computer-readable storage medium having instructions embodied thereon, the instructions being executable by one or more processors to perform a method for determining the impact of failures of information systems within an architecture of information systems, the method comprising:
determining a base set of nodes, each node representing an information system in the architecture;
assigning dependency values between pairs of the nodes in the base set, the dependency values representing a level of dependency between the pairs of the nodes;
determining an intermediate set of nodes representing information systems in the architecture, the information systems represented by the intermediate set of nodes being distinct from the information systems represented by the base set of nodes;
assigning dependency values between pairs of the nodes in the intermediate set and the nodes in the base set, the dependency values representing a level of dependency between the pairs of the nodes;
monitoring operating conditions of the information systems;
assigning an operating condition value to each node base on the operating conditions, whereby the operating condition values represent the operating condition of the corresponding information system; and
determining an operational status of at least one of the information systems based on operating condition values of nodes corresponding to other information systems and corresponding dependency values.

18. The computer-readable storage medium of claim 16, wherein the dependency values are expressed as a number between 0 and 1 wherein 0 represents no dependency and wherein 1 represents a full dependency.

19. The computer-readable storage medium of claim 16, wherein the operating condition values are binary with 1 representing full operation and 0 representing less than full operation.

20. The computer-readable storage medium of claim 18, wherein the method further comprises:
determining a root node that represents the entirety of the architecture; and
assigning dependency values between nodes in the intermediate set and the root node.

21. The computer-readable storage medium of claim 19, wherein the intermediate set of nodes comprises multiple subsets of nodes in a tree structure, wherein each node in each subset of nodes has dependency values between pairs of the nodes therein and the adjacent subset of nodes.

22. The computer-readable storage medium of claim 19, wherein the dependency values are stored as a series of matrices.

23. The computer readable storage medium of claim 17, wherein the architecture accomplishes a mission and the method further comprises determining a best case outcome of the mission and a worst case outcome of the mission.
